(19) United States
(12) Patent Application Publication
(10) Pub. No.: US 2016/0347654 A1
(43) Pub. Date: Dec. 1, 2016

(54) METHOD FOR FORMING LOW EMISSIVITY DOPED ZINC OXIDE FILMS ON A SUBSTRATE

(71) Applicant: AGENCY FOR SCIENCE, TECHNOLOGY AND RESEARCH, Singapore (SG)

(72) Inventors: Gregory Kia Liang Goh, Singapore (SG); Laura-Lynn Liew, Singapore (SG)

(21) Appl. No.: 15/111,392

(22) PCT Filed: Jan. 13, 2015
(86) PCT No.: PCT/SG2015/000006

§ 371 Date: Jul. 13, 2016

(30) Foreign Application Priority Data
Jan. 13, 2014 (SG) 201400265-3

(51) Int. Cl. C03C 17/25; C03C 17/245; C23C 18/12

(52) U.S. Cl. CPC C03C 17/25; C23C 18/1216; C23C 18/1233; C03C 17/245; C03C 2217/216; C03C 2217/24; C03C 2217/74; C03C 2218/111; C03C 2218/32

(57) ABSTRACT

The invention relates to a method for forming low emissivity doped zinc oxide films on a substrate, and in particular, to a method for forming low emissivity gallium doped zinc oxide films on a substrate via a low temperature chemical bath deposition technique.

### CROSS-REFERENCE TO RELATED APPLICATION

This application claims the benefit of priority of Singapore Patent Application No. 201400265-3, filed Jan. 13, 2014, the contents of which being hereby incorporated by reference in its entirety for all purposes.

### TECHNICAL FIELD

The invention relates to a method for forming low emissivity doped zinc oxide films on a substrate, and in particular, to a method for forming low emissivity gallium doped zinc oxide films on a substrate via a low temperature chemical bath deposition technique.

### BACKGROUND

Commercial low emissivity (low-e for short) coatings that can be used on external surfaces are known as hard coats or pyrolytic low-e coatings. This is because they are more stable to moisture as compared to sputtered silver (Ag) based low-e coatings, more commonly known as soft coats. FIG. 5 shows the different types of low-e coatings based on an amount of solar infrared (IR) that is to be prevented from entering a building. A high solar gain low-e is desirable for winter when heat from solar IR is desired so as to minimize heating costs. A low solar gain low-e is desired when heat from solar IR is not desired (e.g. during summer) so as to keep cooling costs down. Therefore, a low solar gain low-e coating is preferred for tropical climates, such as in Singapore. Unfortunately, such performance can only be achieved with soft low-e coatings and such coatings have to be used within insulated glass units (IGU) and not on external surfaces. The best that can be achieved with pyrolytic low-e coatings is the moderate solar gain low-e coatings shown in FIG. 5.

The problem is that pyrolytic coatings are applied on-line onto a float glass by a chemical vapor deposition process at very high temperatures of >600° C. As low-e coated glasses can be 5 times more expensive, it would be desirable if in-house coating can be conducted on bare glass. This is not economical if users employ conventional techniques such as sputtering and chemical vapor deposition.

Further, coatings using such techniques will require significant investment in equipment and trained personnel. In addition, the coatings using current techniques cannot be applied to polymeric substrates like the films and sheets used in solar control films for retro fits.

FIG. 6 shows a single glazed window design formed from a laminate consisting of glass sheets sandwiching a heat absorbing polycarbonate with a low-e coating on the external surface (surface 4) of the glass sheet facing into an enclosure can reduce the solar heat gain factor (G value or G for short) by 27% when compared to a standard double glazed window with low-e coating (compare Tables 4 and 5). But it can also be seen that the visible light transmittance is reduced significantly by 29%. This design requires a hard coat since only the external glass surfaces are available for coating.

TABLE 4
Spectral and thermal performance of a double glazed window
with low-e coating on surface 2 (numbers indicate surfaces
of various glass sheets in laminate referred to in text).

| | | | |
|---|---|---|---|
| Visible light | 0.603 | Solar transmittance | 0.424 |
| transmittance, VLT | | | |
| Visible light | 0.122 | Solar reflectance, front | 0.116 |
| reflectance, front | | | |
| Visible light | 0.156 | Solar reflectance, back | 0.139 |
| reflectance, back | | | |
| Emittance, front | 0.84 | U-value [W/(m²K)] | 2.18 |
| Emittance, back | 0.84 | G-value | 0.515 |

TABLE 5
Spectral and thermal performance of glass laminated heat
absorbing PC window with low-e coating on surface 4.

| | | | |
|---|---|---|---|
| Visible light | 0.427 | Solar transmittance | 0.176 |
| transmittance, VLT | | | |
| Visible light | 0.061 | Solar reflectance, front | 0.048 |
| reflectance, front | | | |
| Visible light | 0.089 | Solar reflectance, back | 0.094 |
| reflectance, back | | | |
| Emittance, front | 0.84 | U-value [W/(m²K)] | 2.99 |
| Emittance, back | 0.296 | G-value | 0.377 |

If the low-e film is coated directly onto the heat absorbing polycarbonate so as to form a solar control film that can be adhered in a retrofit to single glazed windows, then this product must fulfill additional requirements by the Singapore Green Building Council to qualify as a Green product. These requirements are that the light to solar heat gain factor (LSG), which is the ratio VLT/G, must be >1.15 and G <0.61. As can be seen in Table 5, the G requirement is easily satisfied, but the LSG of the laminate with commercial low-e, VLT/G=1.13, which does not qualify as a Green product.

Another form of retrofitting without requiring the replacement of existing single glazed windows is to add another glass sheet (lite) that has a low-e coating facing the inside of the building, effectively forming a double glazed window but with the low-e coating on surface 4 instead of surface 2 that can have thermal and spectral performances approaching that of the conventional double glazed window design with appreciable energy savings.

### SUMMARY

In supplying products for buildings (in this case glazing), it is important to offer the building designer/architect a range of options in terms of tint color, VLT and G values. The present low-e coating is able to reduce the G value significantly ˜16% (compare Tables 3 and 4) but with a more modest reduction in VLT ˜12%.

More importantly, the LSG for a presently coated laminate, such as a gallium doped zinc oxide (GZO for short) coated laminate with heat absorbing PC is 1.23, which qualifies it as a Green Product. In addition, zinc is inexpensive and readily available, thus the making of zinc oxide film is easily achievable and in constant supply. Many hard low-e coatings are made from indium tin oxide and indium is expensive as its supply is getting increasingly scarce. The other material used in the manufacture of low-e coatings is fluorine doped tin oxide and thus toxic fluorine based vaporized precursors are required. On the other hand, zinc oxide is non-toxic and is in fact used in sun tan lotion and other cosmetics.

The crystalline GZO coatings described herein are deposited by a low temperature solution method termed chemical bath deposition at 100° C. or less, such as 90° C. This means that deposition on polymeric substrates is not an issue. In addition, unlike conventional hard low-e coatings that are deposited on-line at the float glass plant, this process can be adopted for coating of bare float glass previously purchased, reducing the overall cost of the glazing since coated glasses are normally ˜5 times more expensive. Furthermore, since the process and equipment are relatively simple and cheap, any party wishing to adopt this process need not require substantial capital injection to purchase sputtering equipment (e.g. vacuum chambers, targets, trained manpower). The coating can be done in a batch process making it even more economical.

Thus, in accordance with one aspect of the invention, a method for forming a low emissivity doped zinc oxide (ZnO) film on a transparent substrate is disclosed.

The method may include depositing a ZnO seed layer on the transparent substrate to form a ZnO seeded substrate.

The method may further include immersing the ZnO seeded substrate in a container containing a precursor solution, wherein the precursor solution comprises zinc nitrate hexahydrate dissolved in deionized water, sodium citrate, and a dopant for the ZnO film.

The method may further include placing the container in an autoclave and heating the autoclave in an oven at 100° C. or less to deposit doped ZnO film on the transparent substrate.

The method may further include drying the deposited doped ZnO film.

According to another aspect of the invention, there is provided a low emissivity transparent substrate.

The low emissivity transparent substrate may include a transparent substrate and a doped zinc oxide (ZnO) film formed on the transparent substrate according to the above method. The doped ZnO film may have a film resistivity of at least 10⁻³ Ωcm and at most 10 Ωcm.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments.

FIG. 1 shows FESEM image of gallium doped zinc oxide (GZO for short) film (a) plan view, and (b) cross-sectional view.

FIG. 2 shows XRD spectra of as-grown GZO films and after heat treatment at 300° C. in air. XRD confirms wurzite ZnO structure.

FIG. 3 shows spectral transmittance/reflectance curves of GZO films on glass (a) before, and (b) after heat treatment at 300° C.

FIG. 4 shows spectral transmittance/reflectance curves of glass laminated heat absorbing polycarbonate window with GZO low-e coating on surface 4 (FIG. 6).

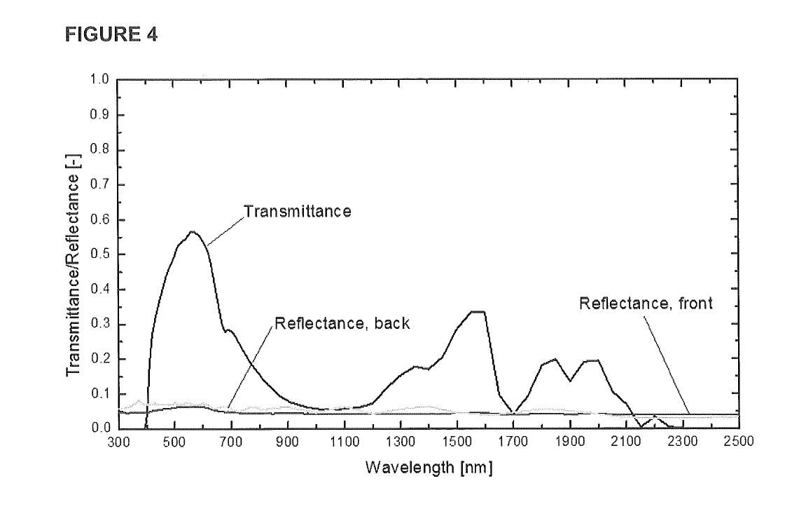

FIG. 5 shows spectral transmittance curves for glazings with low-emittance coatings (Source: Lawrence Berkeley National Laboratory).

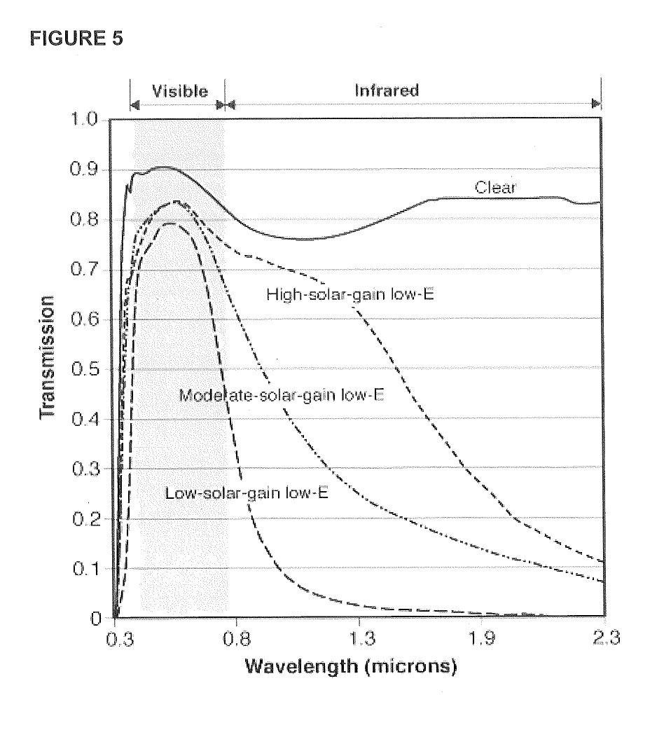

FIG. 6 shows a single glazed window design formed from a laminate consisting of glass sheets sandwiching a heat absorbing polycarbonate with a low-e coating on the external surface (surface 4) of the glass sheet facing into an enclosure.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and changes may be made without departing from the scope of the invention. The various embodiments are not necessarily mutually exclusive, as some embodiments can be combined with one or more other embodiments to form new embodiments.

In accordance with one aspect of the invention, a method for forming a low emissivity doped zinc oxide (ZnO) film on a transparent substrate is disclosed.

For example, the transparent substrate may be a borosilicate glass. Other types of transparent substrates including polymers such as polycarbonates are also possible. In case of the transparent substrate being a glass, the thus-formed low emissivity glass (low-e glass) is glass having low emissivity, which is a functional glass formed by coating or depositing a surface of the glass with a doped zinc oxide layer to reflect solar radiation in hot climate and to store infrared light emitted from an indoor heater in cold climate, thereby realizing energy saving effects.

In present context, the term “emissivity” indicates a degree of emitting infrared energy in an infrared wavelength range. While there is no universally recognized value for emissivity below which a substrate can be known as having low-e, for the purposes of illustration and understanding of present invention, the following scenario provides a guide to determine whether a substrate is considered to possess a low-e or a high-e.

Table 4 shows that for uncoated front and back surfaces, the glass has an emissivity value of 0.84 for each of the front and back surface (Emittance, front; Emittance, back). Table 5 shows that for an uncoated front surface and a commercial coating coated back surface, the glass has an emissivity value of 0.84 and 0.296, respectively (Emittance, front; Emittance, back). With the present doped ZnO film coated on the back surface, the glass now has an emissivity value of 0.338 (reduced from 0.84) (Table 2, Emittance, back), approaching close to the commercial coating emissivity value of 0.296. Thus, in present context, when the emissivity value approaches closer to the value of 0.296 than the uncoated value of 0.84, such as 0.568 or below, preferably 0.55, 0.50, 0.45, or 0.40 and below, the coating is said to be having a low-e.

Present method may include depositing a ZnO seed layer (or seeding layer) on the transparent substrate to form a ZnO seeded substrate.

In various embodiments, the depositing of the ZnO seed layer may include thermal decomposition. Other deposition techniques are also suitable, such as but not limited to, atomic layer deposition, sputtering, spin-coating of nanoparticles, and sol-gel deposition.

In preferred embodiments, the depositing of the ZnO seed layer may include thermally decomposing zinc acetate in an oven. Zinc acetate dihydrate is first dissolved in ethanol. The solution is then drop wise deposited onto the transparent substrate, followed by a quick dipping into ethanol and blown dry. The drop wise deposition, quick dipping and drying is repeated for a few more times before heating the coated transparent substrate in an oven. The coated transparent substrate may be heated in the oven at between 200° C. and 600° C., such as 350° C. for 90 min, for example. Alternative to zinc acetate, other zinc containing chemical may be used for forming the-ZnO seed layer, which may include but is not limited to, zinc nitrate, zinc sulphate, and zinc chloride. Furthermore, the duration of the heating may be increased, i.e. more than 90 min for temperatures less than 350° C., and may be decreased, i.e. less than 90 min for temperatures more than 350° C.

After forming the ZnO seeded substrate, present method may further include immersing the ZnO seeded substrate in a container containing a precursor solution. The container may, for example, be a Teflon liner, glass beaker, or plastic beaker, preferably Teflon liner. In various embodiments, the precursor solution may include zinc nitrate hexahydrate dissolved in deionized water. Alternative to zinc nitrate hexahydrate, other zinc containing chemicals may be used for the precursor solution, which may include but is not limited to, zinc acetate, zinc sulphate, and zinc chloride. The precursor solution may further include sodium citrate, ammonium citrate, or citric acid. A dopant for the ZnO film is also added to the precursor solution.

In one embodiment, the doped ZnO film may include gallium (Ga) doped ZnO film. Accordingly, the dopant added to the precursor solution may include a gallium salt, such as gallium nitrate. Alternatively, other dopants may include indium, aluminium, and other ions with valence of more than 2.

The pH of the precursor solution may be adjusted. The pH of the precursor solution affects the solubility of ZnO and thus the supersaturation required for film growth. Optimal film growth lies in the pH range of 10-12. In embodiments where zinc nitrate hexahydrate and sodium citrate were used for a Ga doped ZnO film, it was found that an optimal pH of 10.9 was obtained by using ammonia to adjust the solution pH. For other zinc and citrate precursors, the optimal pH might not be 10.9 but still falls within the range of 10-12 as stated above.

After the immersion, present method may further include placing the container in an autoclave and heating the autoclave in an oven at 100° C. or less to deposit doped ZnO film on the transparent substrate. Preferably the heating of the autoclave is carried out in a conventional oven at 100° C., 95° C., 90° C., 85° C., 80° C., 75° C., 70° C., 65° C., 60° C., or less.

In one embodiment, the heating of the autoclave is carried out in a conventional oven at 90° C. for 4 h, although other heating temperature and periods are also possible. For example, the heating temperature range may be,between 60° C. and 100° C., and the heating duration may be between 1 and 8 h. The duration increases for lower temperatures and decreases for higher temperatures so that a transparent and adherent film is formed.

During the heating of the autoclave, doped zinc oxide films are formed and deposited on the transparent substrate. Optionally, the coated substrate is removed from the autoclave and rinsed with deionized water, before drying the deposited doped ZnO film.

To increase carrier concentration in the doped ZnO film, present method may further comprise annealing the doped ZnO film after the drying step at 200° C. or more, such as up to 600° C.

In one embodiment, the annealing may be carried out in a box furnace for 1 h in air at 300° C., although other annealing temperatures, gases, and periods are also possible. For example, in addition to air, the annealing may also be carried out in argon, hydrogen, nitrogen, forming gas, or vacuum. The annealing periods are shorter if higher annealing temperatures are employed. Conversely, the annealing periods are longer if lower annealing temperatures are employed.

By employing the above method, a low emissivity transparent substrate according to another aspect is formed.

The low emissivity transparent substrate may include a transparent substrate and a doped zinc oxide (ZnO) film formed on the transparent. The doped ZnO film may have a film resistivity of at least 10⁻³ Ωm and at most 10 Ωcm. The transparency of the resultant doped ZnO film in the visible range is 70% or more.

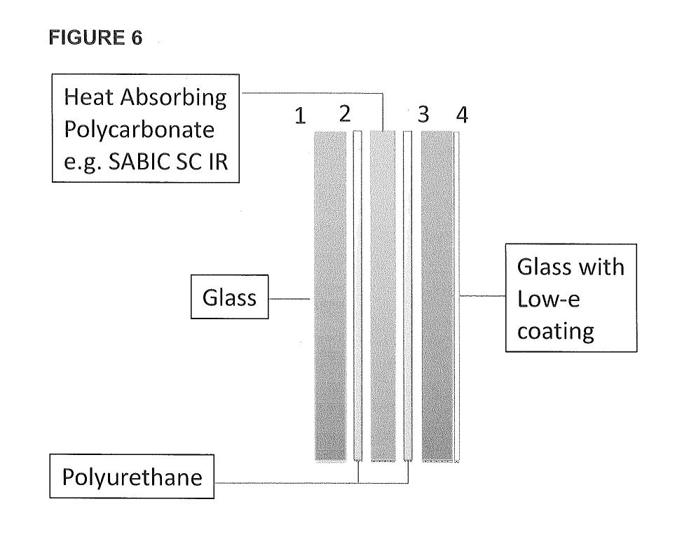

The design of a single glazed window of FIG. 6 having the low emissivity transparent substrate obtained by present method (i.e. surface 4) enables a ratio of visible light transmittance (VLT) to solar heat gain factor (G) (VLT/G) of at least 1.15 and having G of at most 0.61 to be achievable, thereby qualifying as a Green Product.

With the annealing step, present low emissivity transparent substrate may have a carrier concentration of at least 10¹⁹ cm⁻³.

As mentioned in earlier paragraphs, all low-e coatings in current use are mostly deposited by chemical or physical vapour deposition techniques, most at elevated temperatures. The present doped zinc oxide (ZnO) coatings are formed by a chemical bath deposition route at 90° C., which means that deposition on polymeric substrates is possible. This process can be adopted for coating of bare float glass previously purchased, reducing the overall cost of the glazing since coated glasses are normally ˜5 times more expensive. Also, since the process and equipment are relatively simple and cheap, any party wishing to adopt this process need not require substantial capital injection to purchase sputtering equipment.

Most solution deposited ZnO based films are considered for transparent conducting oxide (TCO) applications. As such, high carrier concentration and transparency are required. Thus, it is the object of TCO manufacturers to have as low a resistivity (typically 10⁻³ to 10⁻⁴ Ωcm) as possible. It is therefore surprising to note that present doped ZnO films (e.g. gallium doped ZnO films) having a high resistivity can be useful as a low-e coating.

Further, the morphology of the doped ZnO films grown on the transparent substrate has never been reported and does not look like the typical solution grown film. Indeed, it looks more like a sputtered film.

The chemical bath deposition method utilizes only simple and readily available chemicals such as zinc nitrate and ammonia that are dissolved in deionized water. This makes handling much easier (compared to vapor phase precursors), safer and more easily recoverable. If growth is done in a continuous circulation reactor, then the precursor is actually recyclable.

In addition, the temperature used for the deposition is low (less than 100° C.) so there is no need for environmental control chambers, large and expensive targets or vacuum systems, thereby reducing energy usage.

In conclusion, present method enables the use of low temperature aqueous solution deposited doped ZnO films as low emissivity (low-e) films on transparent substrates despite the high resistivity of the film. Example 1 demonstrates the deposition of a gallium (Ga) doped ZnO film (GZO) on glass substrates, its structure and electrical properties. Example 2 demonstrates the spectral and thermal performances of the GZO coating in combination with heat absorbing polycarbonate in a laminate design.

In order that the invention may be readily understood and put into practical effect, particular embodiments will now be described by way of the following non-limiting examples.

### EXAMPLE 1

This example involves depositing transparent Ga doped ZnO films on glass substrates. A seed layer, in combination with a chemical bath deposition at 90° C. is used to produce Ga doped ZnO films using a conventional oven.

The following steps are involved:

(a) Glass substrates were first washed in piranha solution for duration of 40 min. After which the substrates were thoroughly cleaned with deionized water (DW).

(b) A seed layer was prepared according to the method used by Greene et. al. (L. E. Greene, M. Law, J. Goldberger, F. Kim, J. C. Johnson, Y. Zhang, R. J. Saykally, P. Yang, Angewandte Chemie International Edition 2003, 42, 3031-3034) which involves Zn acetate thermal decomposition on the glass substrate. 0.005M of zinc acetate dihydrate [Zn(CH₃COO)₂.2H₂O, Merck] were dissolved in 10 ml of ethanol. Two drops of solution were drop wise deposited on the substrates and left for about 30 s. The substrates were then dipped quickly into ethanol and blown dry using nitrogen gas. This step was repeated five times. The substrates were then placed in a crucible and subjected to thermal decomposition in a conventional oven, at 350° C. for 90 min. This procedure was carried out twice to ensure a complete and uniform coverage.

(c) The precursor solution was composed of 0.028M zinc nitrate hexahydrate [Zn(NO₃)₂.6H₂O, 98%, Sigma-Aldrich, St. Louis, USA) dissolved in 24 ml of DW in a Teflon liner with 7.08 mM sodium citrate (C₆H₅Na₃O₇.2H₂O, Sigma-Aldrich, St. Louis, USA) added to the solution. Ga was also introduced as a dopant in the form of Gallium nitrate (Ga(NO₃)₃.6H₂O, 99.9%, Sigma-Aldrich]. 3.26 mM of Ga nitrate was added to the above-mentioned precursor solution. Ga is a known dopant for ZnO films that increases the carrier concentration and thus improves the electrical properties of the ZnO film. The pH of the solution was measured and adjusted to 10.9 with ammonia solution (25%, Honeywell). This method has been reported elsewhere as well (D. Andeen, J. H. Kim, F. F. Lange, G. K. L. Goh, S. Tripathy, Adv.Funct.Mater. 2006, 16, 799-804; J. J. Richardson, F. F. Lange, J.Mater.Chem. 2011, 21, 1859-1865; D. Andeen, L. Loeffler, N. Padture, F. F. Lange, Journal of Crystal Growth 2003, 259, 103-109; J. J. Richardson, G. K. L. Goh, H. Q. Le, L. L. Liew, F. F. Lange, S. P. DenBaars, Crystal Growth & Design 2011, 11, 3558-3563). The glass substrate with the seed layer was immersed into the Teflon liner with solution using a sample holder. The side of interest was faced downwards, about 10 mm from the bottom of the Teflon liner. The Teflon liner was then placed into a stainless steel autoclave container.

(d) Ga-doped ZnO films were deposited using a conventional oven (MMM Group Venticell 111- Comfort) at 90° C. for 4 hours.

(e) After 4 hours, the glass substrates with the deposited films are removed from the solution and rinsed in DI water and blown dry gently with a stream of nitrogen gas.

(f) Thermal annealing of the films was then carried out in a box furnace for 1 h in air at 300° C.

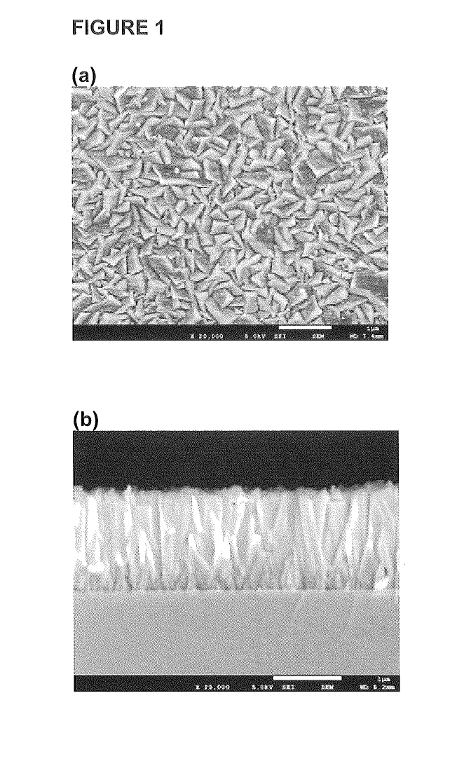

FESEM observations in FIG. 1 reveals a facetted surface in plan view and a film thickness of 1.4 μm in cross-section.

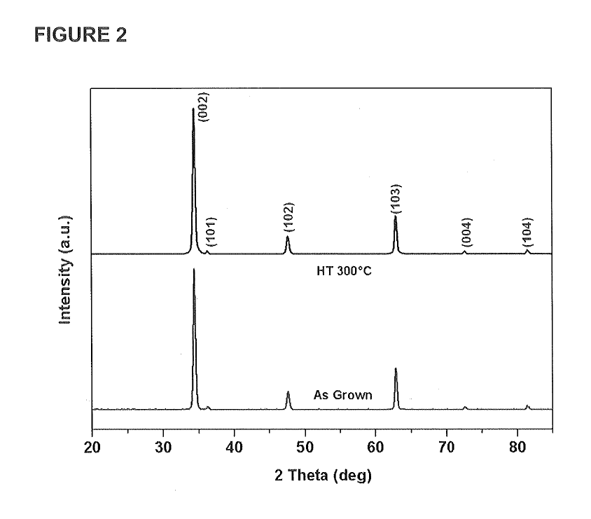

The Ga doped ZnO films are highly crystalline as shown by X-ray diffraction (XRD). FIG. 2 also shows a predominant peak at 2θ=34.4°, corresponding to the (002) plane. Heat treatment (HT) of the films did not degrade the films.

To determine the electrical properties of the GZO films, electrical conductivity was measured using the Hall measurement system in the van der Pauw geometry. ZnO films are intrinsically n-type and because of the Ga dopant, carrier concentration further increases, thus increasing the conductivity of the film. The conductivity further increases with thermal annealing. Table 1 shows the electrical properties obtained for the films grown.

TABLE 1
Electrical properties of Ga-doped ZnO films.

| | Resistivity | Hall mobility | Carrier Concentration |
|---|---|---|---|
| | (ohm-cm) | (cm²/V-s) | (cm⁻³) |
| As-grown | 354.9 | 0.165 | 3.689 × 10¹⁷ |
| HT300° C. air | 1.908 | 0.082 | 9.653 × 10¹⁹ |

### EXAMPLE 2

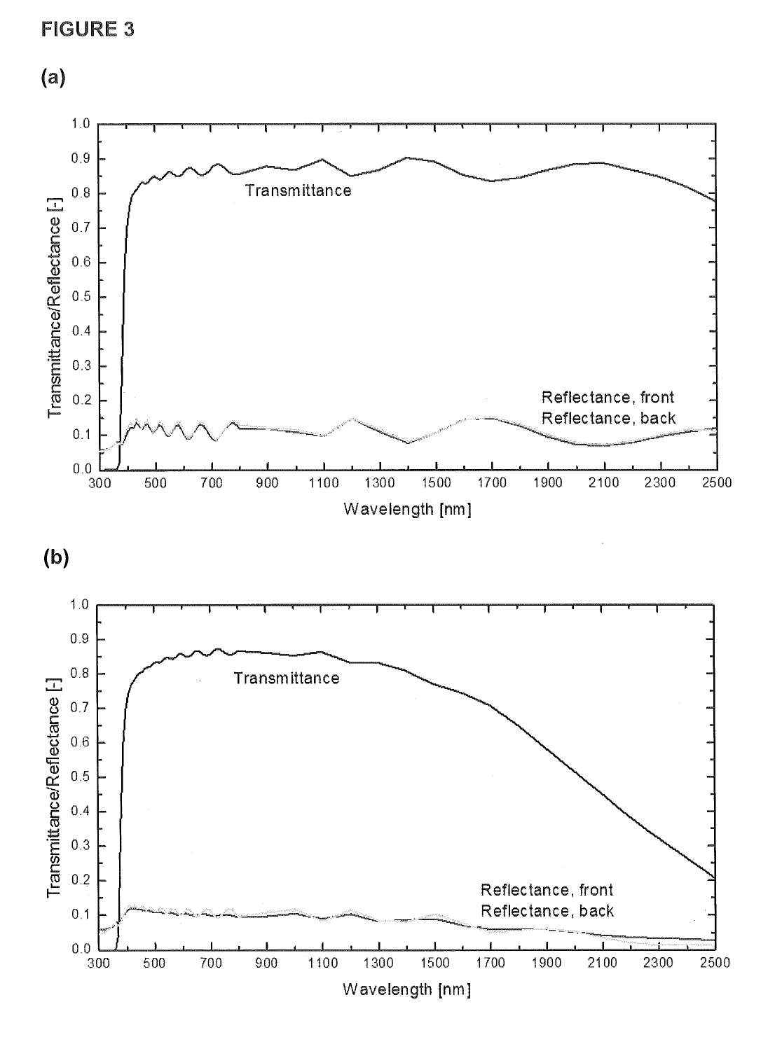

In this example, the as-grown Ga doped ZnO films are transparent, with visible light transmittance of about 80-90% as shown in Table 2 and FIG. 3. FIG. 3 further shows that infrared (IR) absorption only becomes significant after heat treatment which is required before the doping leads to significant enhancements in the carrier concentration. This confirms that the IR absorption and lowered emittance is due to the free electron plasma effect.

TABLE 2
Spectral and thermal performance of heat treated
(300° C. in air) GZO film grown on glass.

| | | | |
|---|---|---|---|
| Visible light | 0.844 | Solar transmittance | 0.801 |
| transmittance, VLT | | | |
| Visible light | 0.106 | Solar reflectance, front | 0.096 |
| reflectance, front | | | |
| Visible light | 0.113 | Solar reflectance, back | 0.101 |
| reflectance, back | | | |
| Emittance, front | 0.851 | U-value [W/(m²K)] | 4.45 |
| Emittance, back | 0.362 | G-value | 0.822 |

When the spectral and thermal performance of the GZO films is combined with that of a heat absorbing polycarbonate, Table 3 shows that the G value is significantly reduced.

TABLE 3
Spectral and thermal performance of glass laminated heat absorbing
polycarbonate window with GZO low-e coating on surface 4 (FIG. 6).

| | | | |
|---|---|---|---|
| Visible light | 0.531 | Solar transmittance | 0.248 |
| transmittance, VLT | | | |
| Visible light | 0.061 | Solar reflectance, front | 0.048 |
| reflectance, front | | | |
| Visible light | 0.070 | Solar reflectance, back | 0.058 |
| reflectance, back | | | |
| Emittance, front | 0.84 | U-value [W/(m²K)] | 3.18 |
| Emittance, back | 0.338 | G-value | 0.432 |

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non- limiting examples. In addition, where features or aspects of the invention are described in terms of Markush groups, those skilled in the art will recognize that the invention is also thereby described in terms of any individual member or subgroup of members of the Markush group.

1. A method for forming a low emissivity doped zinc oxide (ZnO) film on a transparent substrate, comprising:
depositing a ZnO seed layer on the transparent substrate to form a ZnO seeded substrate;
immersing the ZnO seeded substrate in a container containing a precursor solution, wherein the precursor solution comprises zinc nitrate hexahydrate, zinc acetate, zinc sulphate, or other zinc containing chemicals dissolved in deionized water, sodium citrate, ammonium citrate, or citric acid, and a dopant for the ZnO film;
adjusting the pH of the precursor solution to a range of between 10-12;
placing the container in an autoclave and heating the autoclave in an oven at 100° C. or less to deposit doped ZnO film on the transparent substrate; and
drying the deposited doped ZnO film.

2. The method of claim 1, further comprising annealing the doped ZnO film after drying at between 200° C. and 600° C.

3. The method of claim 2, wherein the annealing comprises annealing the doped ZnO film in a box furnace for 1 h in air at 300° C.

4. The method of any one of claims 1-3, wherein heating the autoclave comprises heating the autoclave in the oven at 90° C.

5. The method of claim 4, wherein heating the autoclave comprises heating the autoclave in the oven at 90° C. for 4 h.

6. The method of any one of claims 1-5, wherein depositing the ZnO seed layer comprises thermal decomposition, atomic layer deposition, sputtering, spin-coating of nanoparticles, or sol-gel deposition.

7. The method of claim 6, wherein depositing the ZnO seed layer comprises thermally decomposing zinc acetate, zinc nitrate, zinc sulphate, or other zinc containing chemicals in an oven.

8. The method of claim 7, wherein depositing the ZnO seed layer comprises thermally decomposing zinc acetate, zinc nitrate, zinc sulphate, or other zinc containing chemicals in an oven at between 200° C. and 600° C., preferably at 350° C. for 90 min.

9. The method of any one of claims 1-8, wherein the doped ZnO film is gallium (Ga) doped ZnO film, indium (In) doped ZnO film, or aluminium (Al) doped ZnO film.

10. The method of claim 9, wherein the dopant is a gallium salt.

11. The method of claim 10, wherein the dopant is gallium nitrate.

12. The method of any one of claims 1-11, wherein the transparent substrate is borosilicate glass or polycarbonate.

13. The method of any one of claims 1-12, wherein the pH of the precursor solution is adjusted to 10.9 with a base.

14. A low emissivity transparent substrate comprising:
a transparent substrate; and
a doped zinc oxide (ZnO) film formed on the transparent substrate according to any one of claims 1-12, wherein the doped ZnO film has a film resistivity of at least 10⁻³ Ωcm and at most 10 Ωcm.

15. The low emissivity transparent substrate of claim 14, having a ratio of visible light transmittance (VLT) to solar heat gain factor (G) (VLT/G) of at least 1.15 and having G of at most 0.61.

16. The low emissivity transparent substrate of claim 14 or 15, wherein the doped ZnO film has a carrier concentration of at least 10¹⁹ cm⁻³.
